(19) United States
(12) Patent Application Publication
(10) Pub. No.: US 2009/0282809 A1
(43) Pub. Date: Nov. 19, 2009

(54) Exhaust purification device for internal combustion engine

(75) Inventor: Shunsuke Toshioka, Numazu-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, AICHI-KEN (JP)

(21) Appl. No.: 11/991,087

(22) PCT Filed: Aug. 31, 2006
(86) PCT No.: PCT/IB2006/002385

§ 371 Date: Feb. 27, 2008

(30) Foreign Application Priority Data
Sep. 2, 2005 (JP) 2005-254628

(51) Int. Cl. F02D 43/00; F01N 3/10; F01N 3/00

(52) U.S. Cl. 60/285; 60/301; 60/297

(57) ABSTRACT

There are provided a fuel addition means which adds fuel into the exhaust, a NOx storage reduction catalyst by which NOx which has been stored is reduced by fuel which is added by the fuel addition means, and a control means which, based upon the intake air amount of the internal combustion engine, the fuel supply amount to the internal combustion engine, the target air/fuel ratio during NOx reduction, and the rich continuation period over which this target air/fuel ratio should be continued, calculates an added fuel amount to be added during this rich continuation period, and controls the fuel addition means so that fuel is added by dispersing this calculated added fuel amount over this rich continuation period.

### BACKGROUND OF THE INVENTION

1. Field of the Invention

The invention relates to an exhaust purification device and an exhaust purification method.

2. Description of the Related Art

When reducing NOx which is stored in an strage reduction type NOx catalyst, so called rich spike control is performed, so as to richen the air/fuel ratio of the exhaust which is flowing in that NOx storage reduction catalyst in a spike-like (short time) manner for a comparatively short period. If the amount of fuel which is added into the exhaust during this rich spike control becomes too large, then it percolates through the NOx storage reduction catalyst, and the amount of HC becomes great. Furthermore, if the amount of fuel which is added into the exhaust becomes too small, then the reduction of the NOx which is stored in the NOx storage reduction catalyst is not performed to a sufficient extent. A certain time period is required until the reduction reaction of the NOx which is stored in the NOx storage reduction catalyst is completed. Due to this, if the time period in which the rich state continues (hereinafter termed the “rich continuation period”) is too short, then the reduction of the NOx which is stored in the NOx storage reduction catalyst is not performed to a sufficient extent. On the other hand, if the rich continuation period is too long, then the HC which has become excessive percolates through the NOx storage reduction catalyst, which is undesirable.

In this connection, when the control condition for NOx reduction processing of the NOx storage reduction catalyst holds, control is performed so as, after having increased the rich level of the air/fuel ratio to a maximum level, gradually to decrease it. At this time, the exhaust air/fuel ratio downstream of the NOx storage reduction catalyst is detected, the time period T1 for which it is initially maintained in the neighborhood of stoichiometric is measured, and the maximum rich level is learning compensated based upon that time period T1. Furthermore, the time period T2 at which it is thereafter maintained in the rich state is measured, and the decrease speed of the rich level is learning compensated based upon that time period T2. This type of technique is disclosed in, for example, Japanese Patent Application Publication No. JP(A) 11-62666. According to this technique, it is possible to keep down the amount of exhausted NOx to less than or equal to a certain standard, along with HC and CO.

Since it is desirable to reduce emissions of NOx and HC into the atmosphere, there is a requirement for yet further purification of NOx and HC.

### SUMMARY OF THE INVENTION

The invention takes as its object to provide a technique, for an exhaust purification device for an internal combustion engine, which is capable of further suppressing the emission of NOx and HC into the atmosphere.

In order to solve the above described problems, the exhaust purification device for an internal combustion engine according to the invention is characterized by comprising: a fuel addition means which adds fuel into the exhaust; an NOx storage reduction catalyst, by which NOx which has been stored is reduced by fuel which is added by the fuel addition means; and a control means which, based upon the intake air amount of the internal combustion engine, the fuel supply amount to the internal combustion engine, the target air/fuel ratio during NOx reduction, and the rich continuation period over which this target air/fuel ratio should be continued, calculates an added fuel amount to be added during this rich continuation period, and controls the fuel addition means so that fuel is added by dispersing this calculated added fuel amount over this rich continuation period.

According to the structure described above, the NOx included in the exhaust is stored in the NOx storage reduction catalyst, and thereafter, this NOx can be reduced by adding fuel into the exhaust by the fuel addition means. And, by performing. rich spike control for an adequate time with an adequate air/fuel ratio, it becomes possible to suppress emission of NOx and HC into the atmosphere.

The “intake air amount of the internal combustion engine” is the amount of air which is inhaled into the internal combustion engine, and it would also be acceptable to utilize the amount of exhaust of the internal combustion engine. The “fuel supply amount to the internal combustion engine” is the amount of fuel which is supplied into the cylinders of the internal combustion engine, and, principally, it is the fuel which is supplied in order to generate the engine output. The “target air/fuel ratio” is the air/fuel ratio in the exhaust which is set as the target when adding fuel from the fuel addition means, during reduction of the NOx which is stored in the NOx storage reduction catalyst. Furthermore, the “rich continuation period” is the time period over which that target air/fuel ratio is maintained when, during a single rich spike, the air/fuel ratio of the exhaust is being set to the target air/fuel ratio.

The target air/fuel ratio and rich continuation period can be determined based upon, for example, the temperature of the NOx storage reduction catalyst, the amount of exhaust, and the amount of NOx which is stored in the NOx storage reduction catalyst. When the temperature of the NOx storage reduction catalyst varies, the degree of atomization of the added fuel, and the air/fuel ratio of the exhaust which passes through the NOx storage reduction catalyst vary. Furthermore, the degree of activation of the catalyst changes according to the temperature of the NOx storage reduction catalyst. Due the reduction efficiency for the NOx varying in this manner, the proper values for the target air/fuel ratio and the rich continuation period also can vary. Accordingly, if the target air/fuel ratio and the rich continuation period are determined based upon the temperature of the NOx storage reduction catalyst, it is possible to obtain reduction of the NOx under more suitable conditions. As a result, it is possible to enhance the NOx purification ratio, and moreover to suppress the emission of HC. On the other hand, when the amount of NOx which is stored in the NOx storage reduction catalyst varies, the amount of fuel which is required for reducing this NOx also can vary. Accordingly, by determining the target air/fuel ratio and the rich continuation period based upon the amount of NOx which is stored in the NOx storage reduction catalyst, it is possible further to enhance the NOx purification ratio, and moreover further to suppress the emission of HC.

The air/fuel ratio of the exhaust which flows into the NOx storage reduction catalyst is given by the ratio of the intake air amount of the internal combustion engine, and the total of the fuel supply amount to the internal combustion engine and the amount of fuel added into the exhaust. In other words, it is possible to adjust the air/fuel ratio of the exhaust which flows into the NOx storage reduction catalyst by changing the amount of fuel added into the exhaust. By doing this, it is possible to bring the air/fuel ratio of the exhaust to the target air/fuel ratio. Furthermore, it is possible to adjust the rich continuation period by changing the time period that fuel addition into the exhaust is performed.

Conversely, if the intake air amount of the internal combustion engine, the fuel supply amount to the internal combustion engine, and the target air/fuel ratio are known in advance, then it is possible to calculate the added fuel amount over the rich continuation period.

By changing the added fuel amount which has been obtained in this manner over the rich continuation period, it is possible to bring the air/fuel ratio of the exhaust to the target air/fuel ratio over the rich continuation period. By doing this, it becomes possible to perform fuel addition in correspondence to the temperature of the NOx storage reduction catalyst, the amount of the exhaust, and the amount of NOx which is stored in the NOx storage reduction catalyst. As a result, it is possible to enhance the NOx purification ratio, and to suppress the emission of NOx into the atmosphere. Furthermore, since an appropriate amount of fuel is added, accordingly emission of HC into the atmosphere is suppressed.

With the invention, the control means may disperse the added fuel amount over the rich calculation period by dividing the calculated added fuel amount into a plurality of addition episodes.

In other words, the addition of fuel is not performed continuously over the rich continuation period, but is stopped at least once. If for example a fuel addition valve is used, by stopping the addition of the fuel in this manner, it becomes possible to bring the air/fuel ratio of the exhaust to the target air/fuel ratio over the rich continuation period, without changing the injection pressure of that fuel addition valve.

And, with the invention, the fuel addition means may be a fuel addition valve whose fuel addition ratio can be adjusted, and the control means may disperse the added fuel amount over the rich calculation period by adjusting the fuel injection ratio of the fuel injection valve.

In other words, by varying the fuel injection ratio, which is the value obtained by dividing the fuel injection amount by the fuel injection time, it is possible to adjust the amount of fuel which is added over the rich continuation period. By doing this, it is possible to bring the air/fuel ratio of the exhaust to the target air/fuel ratio over the rich continuation period.

And, with the invention, the control means may change the target air/fuel ratio according to the operational state of the internal combustion engine, taking slightly rich as a standard.

“Slightly rich” means an air/fuel ratio somewhat on the rich side from stoichiometric, and is an air/fuel ratio between, for example, 14.2 and stoichiometric. This “slightly rich” may be the air/fuel ratio at which the reduction of NOx is performed most effectively under certain predetermined operating conditions. By the way, even if the added fuel amount into the exhaust is the same, the air/fuel ratio of the exhaust which passes through the NOx storage reduction catalyst changes, due to the operational state of the internal combustion engine and the state of the NOx storage reduction catalyst. Even in this type of situation, by changing the target air/fuel ratio, it is possible to make the air/fuel ratio of the exhaust which passes through the NOx storage reduction catalyst be an appropriate one.

And, with the invention, the control means may set the target air/fuel ratio the more to the rich side, the lower is the temperature of the NOx storage reduction catalyst.

When the temperature of the NOx storage reduction catalyst is low, sometimes it happens that fuel which has been added into the exhaust is adsorbed by the NOx storage reduction catalyst, or adheres to the wall surfaces of the NOx storage reduction catalyst. Although this fuel which has thus been adsorbed or adhered gradually evaporates, the amount of fuel which flows along with the exhaust is decreased due to this adsorption or adherence of fuel. Because of this, the air/fuel ratio of the exhaust deviates towards the lean side. In this case, it is possible to bring the air/fuel ratio of the exhaust to slightly rich by increasing the amount of added fuel. In other words, by the target air/fuel ratio being set more towards the rich side the lower is the temperature of the NOx storage reduction catalyst, the air/fuel ratio of the exhaust which passes through the NOx storage reduction catalyst becomes adequate.

And, with the invention, the smaller is the amount of the exhaust, the more to the rich side does the control means set the target air/fuel ratio.

When the intake air amount to the internal combustion engine is small, the amount of exhaust also becomes small, and the flow speed of the exhaust becomes slow. Since, when fuel is added into the exhaust whose flow speed is slow, this fuel diffuses within the exhaust before it arrives at the NOx storage reduction catalyst, accordingly the air/fuel ratio of the exhaust deviates towards the lean side. In this case as well, by increasing the amount of added fuel, it is possible to bring the air/fuel ratio of the exhaust to be slightly rich. In other words, by setting the target air/fuel ratio more towards the rich side, the smaller the amount of the exhaust is, the air/fuel ratio of the exhaust which passes through the NOx storage reduction catalyst becomes adequate.

And, with the invention, the control means may determine the rich continuation period as the value at which the NOx purification ratio becomes maximum, for the temperature of the NOx storage reduction catalyst point and the amount of NOx which is stored in the NOx storage reduction catalyst at the present time point.

Here, if the added fuel amount for a single rich spike is fixed, the shorter is the rich continuation period, in other words the higher is the fuel injection ratio, the lower does the target air/fuel ratio become, and the larger does the added fuel amount per unit time become. Due to this, the amount of fuel which percolates through the NOx storage reduction catalyst becomes large, since the fuel does not react with that catalyst when the rich continuation period is too short. As a result, the purification ratio of the NOx decreases. And, since the HC purification ratio also decreases, the HC density more downstream than the NOx storage reduction catalyst also becomes high. Conversely, the longer is the rich continuation period, in other words the lower is the fuel injection ratio, the higher does the target air/fuel ratio become, and the smaller does the added fuel amount per unit time become. Due to this, when the rich continuation period becomes too long, then the atmosphere becomes lean, and the reduction of NOx becomes sluggish. As a result, the purification ratio of the NOx decreases. In this case, since the HC purification ratio becomes higher, the HC density more downstream than the NOx storage reduction catalyst becomes low. If the fuel injection ratio is not changed but the rich continuation period is made longer, in other words if, while increasing the added fuel amount in a single rich spike, the rich continuation period is made to be long, then the longer the rich continuation period becomes, the higher does the NO purification ratio become. However the fuel consumption is worsened, since the fuel comes to be added in an excessive amount.

If, in this manner, the added fuel amount for a single rich spike is fixed, the NOx purification ratio decreases both when the rich continuation period is too short, and when it is too long. In other words, there is a correlation between the rich continuation period and the NOx purification ratio, and a rich continuation period exists which makes the NOx purification ratio be maximum. This rich continuation period which makes the NOx purification ratio be maximum is correlated with the temperature of the NOx storage reduction catalyst and with the amount of the exhaust Due to this, it is possible to obtain the rich continuation period which makes the NOx purification ratio be maximum, based upon the temperature of the NOx storage reduction catalyst and upon the amount of the exhaust.

And, with the invention, when the intake air amount per unit time is termed Ga, the amount of fuel supplied to the internal combustion engine per unit time is termed Qm, the target air/fuel ratio is termed AF, the rich continuation period is termed T, and the added fuel amount, which is the total amount of fuel added during the rich continuation period, is termed Qad, the control means may calculate the added fuel amount using the following equation:

Qad=((Ga×T)/AF)−Qm×T.

This equation can be obtained from the relationship between the values when the ratio between the total amount of air which passes through the NOx storage reduction catalyst during the rich continuation period, and the total amount of fuel, has been set as the target air/fuel ratio AF. Here, the total amount of air is Ga, and the total amount of fuel is Qm×T+Qad.

By adding the added fuel amount Qad calculated by this equation over the rich continuation period T, the air/fuel ratio of the exhaust which passes through the NOx storage reduction catalyst becomes the target air/fuel ratio. As a result, the NOx purification ratio is enhanced. Furthermore, since the addition of excess fuel is suppressed, accordingly the emission of HC into the atmosphere engendered due to fuel percolating through the NOx storage reduction catalyst is suppressed.

And, in order to solve the above described problem, the exhaust purification method for an internal combustion engine according to the invention is characterized in that, based upon the NOx purification ratio and the HC purification ratio in an NOx storage reduction catalyst, the number of times of fuel injection, or the fuel injection ratio, to that NOx storage reduction catalyst is varied. As previously described, when the fuel injection ratio changes, the air/fuel ratio and/or the rich continuation period of the NOx storage reduction catalyst change. Due to this, the NOx purification ratio and the HC purification ratio of the NOx storage reduction catalyst also change. And, by varying the fuel injection ratio, it is possible to obtain the desired NOx purification ratio or HC purification ratio. Moreover, since it is possible to change the air/fuel ratio and/or the rich continuation period of the NOx storage reduction catalyst by varying the number of times of fuel injection, accordingly it is possible to obtain the desired NOx purification ratio or HC purification ratio. Such change of the number of times of fuel injection may be made, for example, by varying the addition period or the addition interval.

According to the exhaust purification device and the exhaust purification method for an internal combustion engine according to the invention, it is possible to suppress the emission of NOx and HC into the atmosphere to a greater extent.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a figure schematically showing the structure of the intake and exhaust systems of an internal combustion engine to which an exhaust purification device for an internal combustion engine according to a first embodiment is applied;

FIG. 2 is a time chart showing transitions of the air/fuel ratio of the exhaust;

FIG. 3 is a figure showing the relationship between fuel addition time, and NOx purification ratio and HC density;

FIG. 4 is a flow chart showing the flow of a calculation for added fuel amount, according to the first embodiment;

FIG. 5 is a schematic structural diagram showing the vicinity of injection apertures of a fuel addition valve whose fuel injection ratio can be changed;

FIG. 6 is a figure showing the relationship between the lift amount of a needle and the fuel injection ratio;

FIG. 7 is a figure showing the relationship between the fuel addition pressure and the fuel injection ratio;

FIGS. 8A and 8B are time charts showing, upon the same time axis, the waveform of a command signal of an ECU which is sent to the fuel addition valve, and changes of the air/fuel ratio corresponding to this waveform: FIG. 8A is a time chart showing transitions of the command signal of the ECU, and FIG. 8B is a time chart showing transitions of the air/fuel ratio;

FIG. 9 is a flow chart showing the flow when performing fuel addition in a divided manner, according to the first embodiment,

FIG. 10 is a figure showing the relationship between the exhaust temperature or the temperature of a NOx catalyst, and the fuel addition compensation amount; and

FIG. 11 is a figure showing the relationship between the intake air amount and the fuel addition compensation amount.

### DETAILED DESCRIPTION OF THE PREFERRED EMBODIMENTS

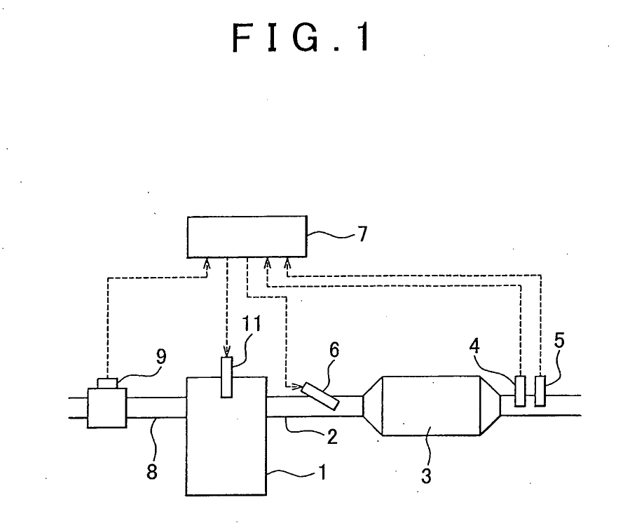

A first embodiment of the invention will now be explained. FIG. 1 is a figure schematically showing the structure of the intake and exhaust systems of an internal combustion engine 1 to which an exhaust purification device for an internal combustion engine according to a first embodiment is applied.

The internal combustion engine 1 shown in FIG. 1 is a water cooled type four cycle diesel engine.

A fuel injection valve 11 is provided to the internal combustion engine 1, and supplies fuel into a cylinder of that internal combustion engine.

Furthermore, an exhaust passage is provided to the internal combustion engine 1, and communicates to a combustion chamber thereof. At its downstream, this exhaust passage 2 is communicated to the atmosphere.

Partway along the exhaust passage, there is provided a NOx storage reduction catalyst 3 (hereinafter termed an NOx catalyst). When the density of the oxygen in the flowing exhaust is high, this NOx catalyst 3 stores NOx in the exhaust, while, when the density of the oxygen in the flowing exhaust is low and moreover a reducing agent is present, it reduces the NOx which has thus been stored.

Furthermore, an air/fuel ratio sensor 4 which outputs a signal corresponding to the air/fuel ratio of the exhaust flowing within the exhaust passage 2, and an exhaust temperature sensor 5 which outputs a signal corresponding to the temperature of the exhaust flowing within the exhaust passage 2, are fitted to the exhaust passage 2, more downstream than the NOx catalyst 3. The temperature of the NOx catalyst 3 is detected by this exhaust temperature sensor 5.

A fuel addition valve 6 is provided to the exhaust passage 2, more upstream than the NOx catalyst 3, and adds fuel (diesel oil), which is a reducing agent, into the exhaust which flows in the exhaust passage 2. Upon a signal from an ECU 7 which will be described hereinafter, this fuel addition valve 6 opens and thereby injects fuel into the exhaust. This fuel which has been injected from the fuel addition valve 6 into the exhaust passage 2 richens the air/fuel ratio of the exhaust flowing from the upstream of the exhaust passage 2. And, during NOx reduction, so called rich spike control is performed by richening the air/fuel ratio of the exhaust which is flowing into the NOx catalyst 3 in a spike-like (short time) manner for a comparatively short period. In this embodiment, the fuel addition valve 6 corresponds to the fuel addition means of the invention.

Furthermore, an intake passage 8 is connected to the internal combustion engine 1, and communicates to its combustion chamber. Partway along this intake passage 8, there is provided an air flow meter 9 which outputs a signal corresponding the amount of air which is flowing in the intake passage 8. The intake air amount of the internal combustion engine 1 is detected by this air flow meter 9.

To this internal combustion engine 1 having the structure described above, there is provided an ECU 7, which is an electronic control unit for controlling this internal combustion engine 1. This ECU 7 is a unit which controls the operational state of the internal combustion engine 1, according to the operating conditions of the internal combustion engine 1 and the demands of the driver.

The air/fuel ratio sensor 4, the exhaust temperature sensor 5, and the air flow meter 9 are connected to this ECU 9 via electrical wiring, and thereby it is arranged for their output signals to be inputted to the ECU 9.

On the other hand, the fuel injection valve 11 and the fuel addition valve 6 are connected to the ECU 7 via electrical wiring, and thereby the fuel injection valve 11 and the fuel addition valve 6 are controlled by the ECU 7.

Moreover, in this embodiment, when performing reduction of the NOx which is stored in the NOx catalyst 3, the added fuel amount from the fuel addition valve 6 is adjusted, so that a predetermined air/fuel ratio is maintained for a predetermined time period.

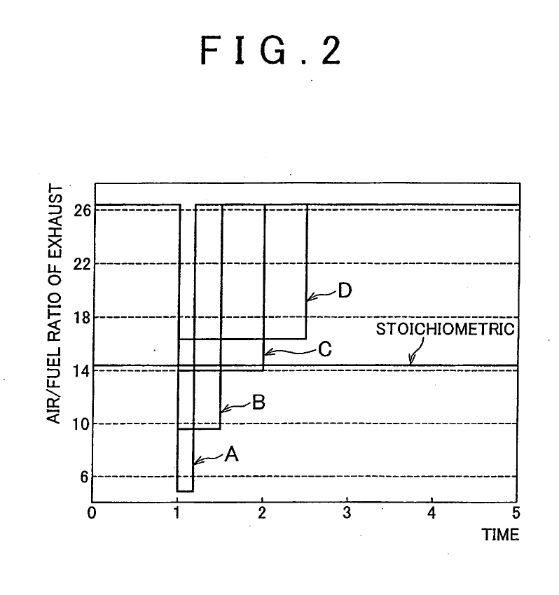

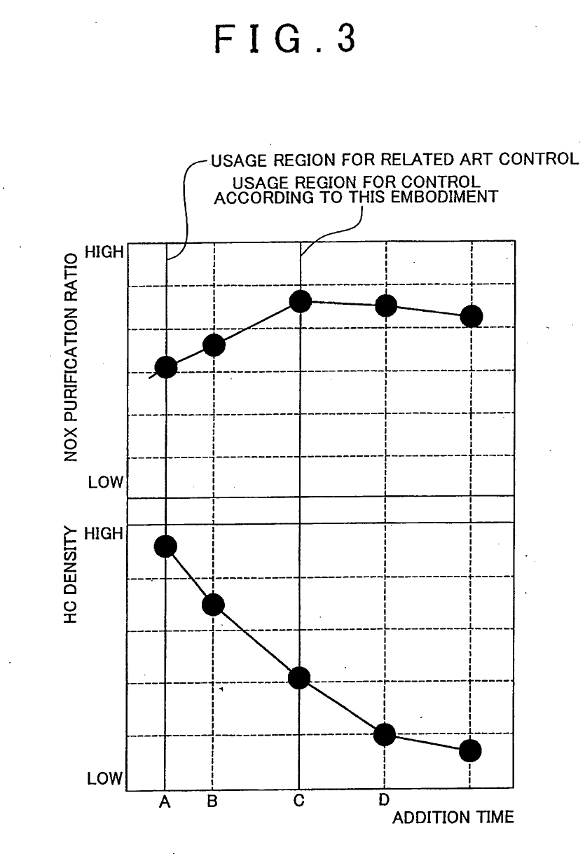

FIG. 2 is a time chart showing transitions of the air/fuel ratio of the exhaust The symbol A in FIG. 2 is for when the added fuel amount per unit time is large and moreover the addition time is short, in which case the air/fuel ratio of the exhaust is the lowest. And, in order, the added fuel amount per unit time for the symbols B, C, and D becomes lower and moreover the fuel addition time becomes longer. Furthermore, FIG. 3 is a figure showing the relationship between the fuel addition time, and the NOx purification ratio and the HC density. The same symbols in FIG. 2 and FIG. 3 (A, B, C, and D) denote fuel addition under the same conditions. In FIG. 3, the fuel addition time is the time period in which fuel is added from the fuel addition valve 6 in a single rich spike. Furthermore, the NOx purification ratio indicates the proportion of NOx, among the NOx stored in the NOx storage reduction catalyst, which has been reduced. If all of the stored NOx has. been reduced, then the NOx purification ratio is 100%. The HC density indicates the maximum value of the density of HC which flows out of the NOx catalyst 3.

In the state shown by the symbol A, the fuel addition time is the shortest, and moreover a large amount of fuel is added in this short time period. Due to this, the air/fuel ratio is the lowest. However, the HC density is the highest, since HC which has not been reacted by the NOx catalyst 3 flows out from the NOx catalyst 3. On the other hand the NOx purification ratio becomes low, since the amount of HC becomes small due to the NOx being reduced. In a technique related to the invention, when fuel is added during NOx reduction, a state like that shown by the symbol A comes about, for example.

On the other hand, in the state shown by the symbol D, the fuel addition time is the longest. Due to this, the air/fuel ratio becomes the highest. Since, in this case, the amount of HC which is reacted by the NOx catalyst 3 becomes high, accordingly the HC density is the lowest. However, the NOx purification ratio becomes low, since the air/fuel ratio of the exhaust flowing in the NOx catalyst becomes lean.

In the state shown by the symbol C, the NOx purification ratio becomes the highest. In this state shown by C, the air/fuel ratio of the exhaust flowing in the NOx catalyst 3 becomes slightly on the rich side of stoichiometric (slightly rich).

It is possible to enhance the NOx purification ratio by making the air/fuel ratio of the exhaust flowing in the NOx catalyst 3, and the time period over which this air/fuel ratio of the exhaust is continued, be those in which the NOx purification ratio is in the highest state. Furthermore, since the amount of HC which percolates through the NOx catalyst 3 decreases, it is possible to suppress the emission of HC into the atmosphere. In this embodiment, by fuel addition during NOx reduction, the target air/fuel ratio and the rich continuation period are set as shown by the symbol C.

Next, the flow of the calculation of the added fuel amount according to this embodiment will be explained.

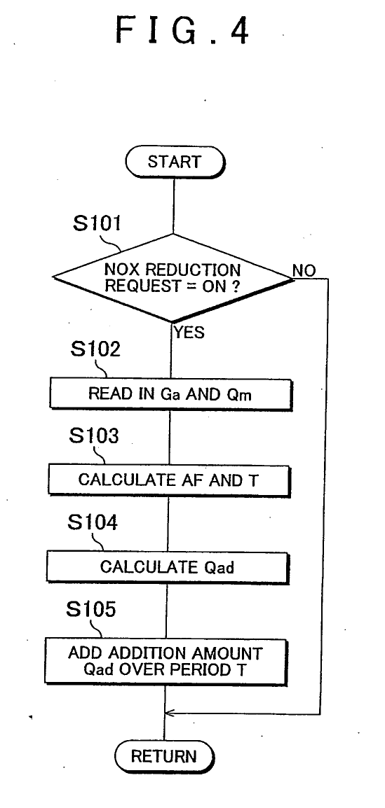

FIG. 4 is a flow chart showing the flow of the calculation for added fuel amount, according to this embodiment. This flow is executed repeatedly at a predetermined time interval.

In a step S101, a decision is made as to whether a NOx reduction request flag, which shows whether or not there is a request for reduction of the NOx which is stored in the NOx catalyst 3, is ON or not. This NOx reduction request flag is turned ON when a requirement has arisen to reduce the NOx which is stored in the NOx catalyst 3. For example, this NOx reduction request flag is turned ON when the vehicle has run for a predetermined distance, or when the vehicle has run for a predetermined time period, or the like.

If an affirmative decision has been made in the step S101, then the flow of control proceeds to the step S102. On the other hand, if a negative decision has been made, then this routine temporarily terminates.

In the step S102, the intake air amount Ga and the fuel injection amount Qm from the fuel injection valve 11 are read in. The intake air amount Ga is obtained from the air flow meter 9. And the fuel injection amount Qm is obtained from the command value of the ECU 7. Each of these values is a value per unit time.

In a step S103, a target air/fuel ratio AF and a rich continuation period T are calculated, based upon the temperature of the NOx catalyst 3 and the requested NOx reduction amount. The target air/fuel ratio AF is an air/fuel ratio which is used as a target when decreasing the air/fuel ratio by adding fuel from the fuel addition valve 6 during rich spike control. Furthermore, the rich continuation period T is a target value of time period during which the air/fuel ratio of the exhaust is to become the target air/fuel ratio AF over a single rich spike. The temperature of the NOx catalyst 3 may be obtained from the exhaust temperature sensor 5. The requested NOx reduction amount is the NOx amount which is to be reduced by the rich spike control; it would also be acceptable to arrange for it to be the amount of NOx which is stored in the NOx catalyst 3. This requested NOx reduction amount is calculated based upon the running distance of the vehicle, or upon its running time. Furthermore, the amount of stored NOx obtained from the operational state of the internal combustion engine may be integrated, and this value may be set as the requested NOx reduction amount.

The target air/fuel ratio AF and the rich continuation period T are calculated from a map, in which the temperature of the NOx catalyst 3 and the requested NOx reduction amount are parameters. For example, the lower is the temperature of the NOx catalyst 3, the larger does the amount of fuel which adheres to the wall surfaces of the NOx catalyst 3 become. Due to this, the target air/fuel ratio AF becomes lower, so that the fuel injection amount per unit time is increased. Furthermore, the greater the requested NOx reduction amount becomes, the longer does the rich continuation period T become, since the time period required for the reduction of the NOx is the longer. This map is obtained in advance by experimentation, so as to make the NOx purification ratio as large as possible, and is stored in the ECU 7. By substituting the temperature of the NOx catalyst 3 and the requested NOx reduction amount in this map, it is possible to obtain the target air/fuel ratio AF and the rich continuation period T.

the target air/fuel ratio AF and the rich continuation period T may be calculated by considering other conditions, than the temperature of the NOx catalyst 3 and the requested NOx reduction amount.

In a step S104, the added fuel amount Qad is calculated. This added fuel amount Qad is the total amount of fuel which is added during the rich continuation period T. The added fuel amount Qad is calculated from the Equation below:

Qad=((Ga×T)/AF)−Qm×T

In other words, the total intake air amount during the rich continuation period T is given by (Ga×T), and the total amount of fuel is given by (Ga×T)/AF). By subtracting the amount of fuel (Qm×T) which is supplied to within the cylinder from this total amount of fuel (Ga×T)/AF), it is possible to calculate the amount of fuel which must be added during the rich continuation period T.

In a step S105, the added fuel amount Qad is added over the rich continuation period T. In this embodiment, in order to perform this addition, the amount of fuel per unit time added from the fuel addition valve 6 is changed. This added fuel amount per unit time may be changed by the method described below.

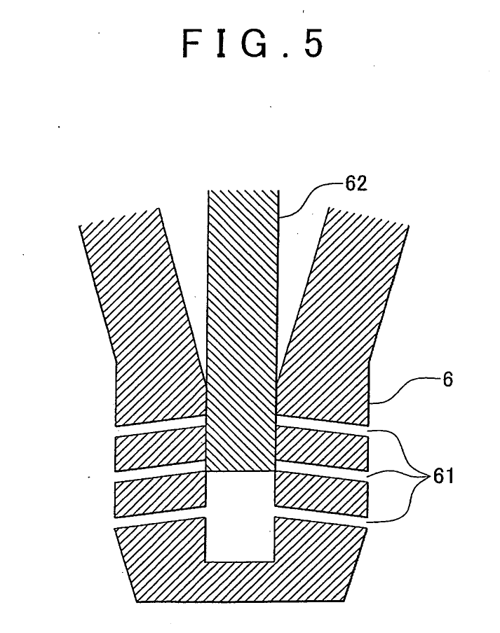

FIG. 5 is a schematic structural diagram of the vicinity of an injection aperture 61 of a fuel addition valve whose fuel injection ratio can be changed. This fuel addition valve 6 comprises a plurality of injection apertures 61, and the number of these injection apertures 61 which are opened is changed according to the lift amount of a needle 62.

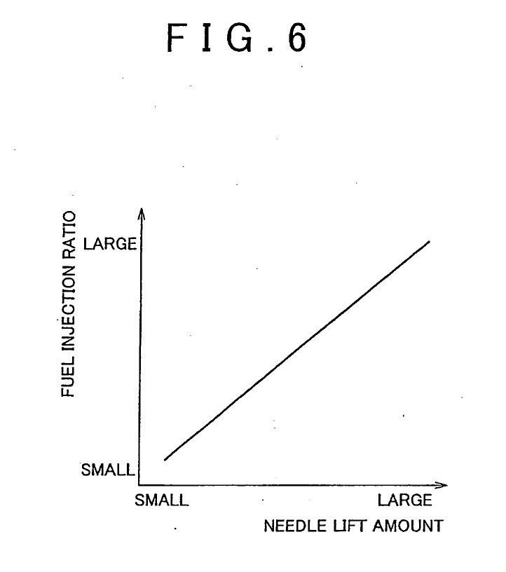

FIG. 6 is a figure showing the relationship between the lift amount of the needle 62 and the fuel injection ratio. When the lift amount of the needle is small, the fuel injection ratio becomes low, since the number of injection apertures 61 which are opened is low. The greater the lift amount of the needle 62 becomes, the greater does the number of injection apertures 61 which are opened become, so the greater does the fuel injection ratio become. And, the lower is the target air/fuel ratio A/F, the greater is the lift amount of the needle 62 made to be, so the greater does the fuel injection ratio become. By adjusting the fuel injection ratio in this manner, it is possible to change the added fuel amount per unit time.

Moreover, it is also possible to change the added fuel amount per unit time by adjusting the fuel addition pressure. In concrete terms, a device which adjusts the fuel addition pressure is provided part way along a passage for supplying fuel to the fuel addition valve 6. It is possible for the ECU 7 to vary the fuel addition pressure by controlling this device.

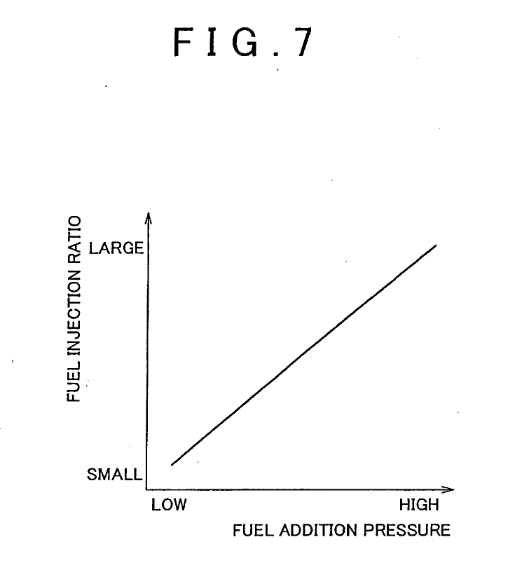

FIG. 7 is a figure showing the relationship between the fuel addition pressure and the fuel injection ratio. Since the fuel injection ratio also becomes greater by increasing the fuel addition pressure, it is possible thereby to vary the added fuel amount per unit time. In other words, the fuel addition pressure is set higher, the lower is the target air/fuel ratio AP.

As explained above, according to this embodiment, it is possible to set the target air/fuel ratio and the rich continuation period so as to attain the highest value of the NOx purification ratio. Furthermore, it is possible to suppress the percolation of HC through the NOx catalyst 3, since the air/fuel ratio of the exhaust which is flowing in the NOx catalyst 3 is not excessively rich. As a result, the emission of HC into the atmosphere is suppressed. Furthermore, the fuel consumption is enhanced, since the NOx is reduced with good efficiency.

In the above step S105, the added fuel amount Qad may be injected while dividing it into a plurality of injection episodes during the target rich continuance period T.

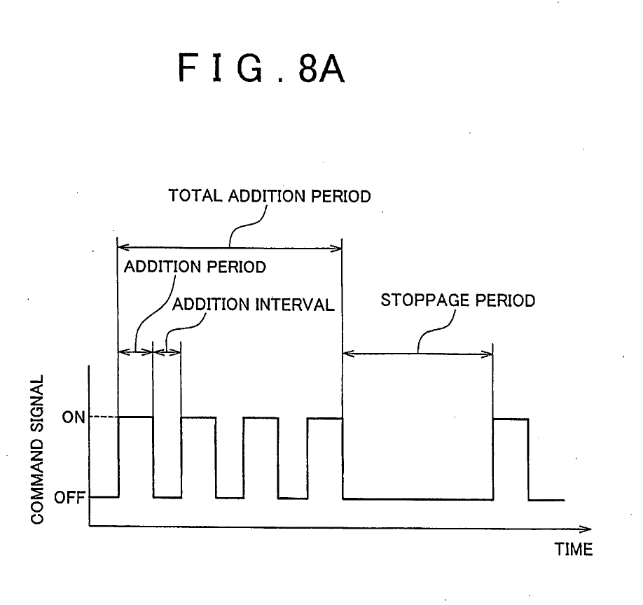

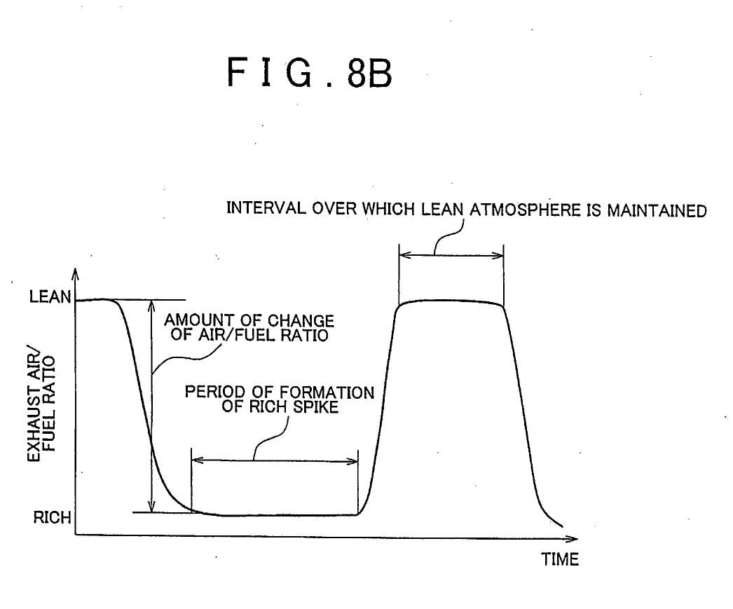

FIGS. 8A and 8B are time charts showing, upon the same time axis, the waveform of the command signal from the ECU 7 which is sent to the fuel addition valve, and changes of the air/fuel ratio corresponding to this waveform. FIG. 8A is a time chart showing transitions of the command signal of the ECU 7. And FIG. 8B is a time chart showing transitions of the air/fuel ratio.

The fuel addition valve 6 is opened, and fuel is injected, when the command signal shown in FIG. 8A goes into the ON state (“ON”). By performing the addition of fuel, the air/fuel ratio of the exhaust which is flowing in the NOx catalyst 3 becomes lower (a rich spike is formed). Here, the longer the addition period (refer to FIG. 8A) is made, and the shorter the addition interval (refer to FIG. 8A) is made, the greater does the amount of change of the air/fuel ratio (refer to FIG. 8B) become. Furthermore, the longer the total addition period (refer to FIG. 8A) is made, the longer does the period of formation of the rich spike (refer to FIG. 8B) become. On the other hand, the length of the fuel addition stoppage period (refer to FIG. 8A) corresponds to the length of the interval over which a lean atmosphere is maintained (refer to FIG. 8B).

In this embodiment, the number of divisions of the added fuel amount Qad is made as large as possible, so that the air/fuel ratio of the exhaust approaches to uniform. Due to this, the addition period in FIG. 8A is set to the minimum injection period to which the fuel addition valve 6 can be set (the minimum injection period TQmin). This minimum injection period TQmin is determined according to the performance of the fuel addition valve 6.

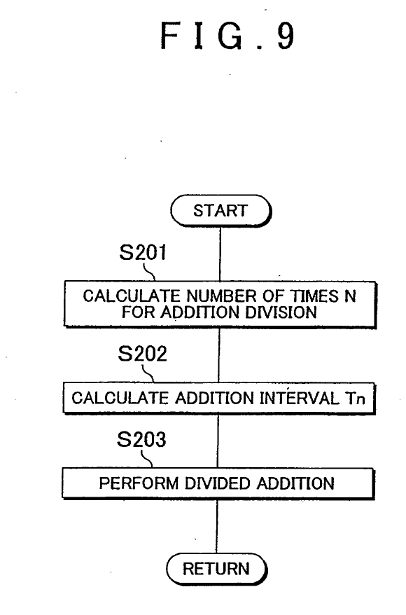

FIG. 9 is a flow chart showing the flow when performing fuel addition in a divided manner, according to this embodiment. This routine is processed instead of executing the above step S105.

In a step S201, a number of times N into which fuel addition is to be divided is calculated based upon the added fuel amount Qad and the minimum addition amount Qmin of the fuel addition valve. This number of times for dividing N is obtained from the following Equation:

N=Qad/Qmin

The minimum addition amount Qmin is the amount of fuel that is added in the minimum injection period TQmin.

In a step S202, the addition interval Tn is calculated, based upon the minimum addition period TQmin, the addition period T, and the number of times for dividing N. This addition interval Tn is obtained from the following Equation:

Tn=(T−TQmin×N)/(N−1)

In a step S203, divided addition is performed based upon the addition interval Tn and the number of times for dividing N, which have been obtained by the steps described above.

It is also possible to maintain the target air/fuel ratio over the rich continuation period by performing the fuel addition while dividing it up in this manner.

A second embodiment of the invention will now be explained. In this embodiment, in addition to the structure of the first embodiment, the added fuel amount is varied according to the state of the NOx catalyst 3, or according to the operational state of the internal combustion engine 1. The other structures are the same as in the first embodiment.

When the temperature of the NOx catalyst 3 or the exhaust temperature is high, the atomization of the fuel which is added from the fuel addition valve 6 is promoted. Due to this, the amount of fuel which adheres to the wall surfaces of the exhaust passage 2 or the like is reduced. In this case, it is possible to reduce the amount of fuel which is required for bringing the air/fuel ratio of the exhaust flowing in the NOx catalyst 3 to the target air/fuel ratio. Furthermore, since the amount of exhaust becomes greater when the intake air amount is large, accordingly the time period until the fuel which has been added from the fuel addition valve 6 reaches the NOx catalyst 3 becomes shorter, and diffusion of the fuel is suppressed. Due to this, increase of the air/fuel ratio is suppressed. As a result, it is possible further to reduce the amount of fuel which is required for bringing the air/fuel ratio of the exhaust flowing in the NOx catalyst 3 to the target air/fuel ratio.

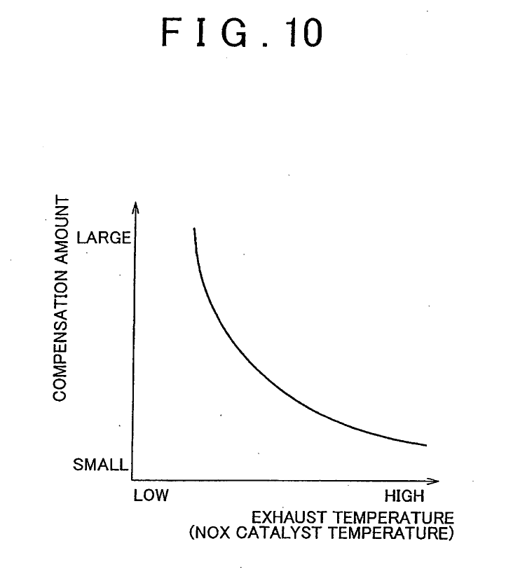

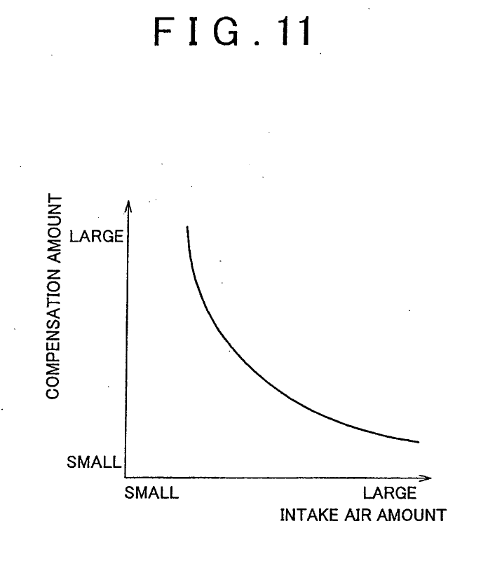

FIG. 10 is a figure showing the relationship between the exhaust temperature or the temperature of the NOx catalyst 3, and the fuel addition compensation amount. The temperature of the exhaust or the temperature of the NOx catalyst 3 may be obtained from the exhaust temperature sensor 5. And FIG. 11 is a figure showing the relationship between the intake air amount and the fuel addition compensation amount. The intake air amount may be obtained from the air flow meter 9.

Compensation is performed to make the added fuel amount the greater, the greater is the compensation amount obtained based upon this figure. By doing this, the added fuel amount is varied according to the temperature of the NOx catalyst 3, the exhaust temperature, the intake air amount, or the amount of exhaust. As a result, it is possible to bring the air/fuel ratio of the exhaust which passes through the NOx catalyst 3 closer to the target air/fuel ratio.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1-10. (canceled)

11. An exhaust purification device for an internal combustion engine, comprising:
a fuel addition means which adds fuel to the exhaust;
a NOx storage reduction catalyst, by which NOx which has been stored is reduced by fuel which is added by the fuel addition means; and
a control means which, based upon the intake air amount of the internal combustion engine, the fuel supply amount to the internal combustion engine, the target air fuel ratio during NOx reduction, and the rich continuation period over which this target air fuel ratio should be continued, calculates an added fuel amount to be added during this rich continuation period and controls the fuel addition means so that fuel is added by dispersing this calculated added fuel amount over this rich continuation period.

12. An exhaust purification device for an internal combustion engine according to claim 11, wherein the control means disperses the added fuel amount over the rich calculation period by dividing the calculated added fuel amount into a plurality of addition episodes.

13. An exhaust purification device for an internal combustion engine according to claim 11, wherein the fuel addition means is a fuel addition valve whose fuel addition ratio can be adjusted, and the control means disperses the added fuel amount over the rich calculation period by adjusting the fuel injection ratio of the fuel injection valve.

14. An exhaust purification device for an internal combustion engine according to claim 11, wherein the control means changes the target air fuel ratio according to the operational state of the internal combustion engine, taking slightly rich as a standard.

15. An exhaust purification device for an internal combustion engine according to claim 14, wherein the lower is the temperature of the NOx storage reduction catalyst, the more to the rich side does the control means set the target air fuel ratio.

16. An exhaust purification device for an internal combustion engine according to claim 14, wherein the smaller is the amount of the exhaust, the more to the rich side does the control means set the target air fuel ratio.

17. An exhaust purification device for an internal combustion engine according to claim 11, wherein the control means determines the rich continuation period as the value at which the NOx purification ratio becomes maximum, for the temperature of the NOx storage reduction catalyst and the amount of NOx which is stored in the NOx storage reduction catalyst at the present time.

18. An exhaust purification device for an internal combustion engine according to claim 11, wherein, when the intake air amount per unit time is termed Ga, the amount of fuel supplied to the internal combustion engine per unit time is termed Qm, the target air fuel ratio is termed AF, the rich continuation period is termed T, and the added fuel amount, which is the total amount of fuel added during the rich continuation period, is termed Qad, the control means calculates the added fuel amount using the following equation:
Qad=((Ga×T)/AF)−Qm×T

19. An exhaust purification method for an internal combustion engine equipped with a NOx storage reduction catalyst by which NOx which has been stored is reduced by fuel which is added by a fuel addition means, characterized by the steps:
adding fuel to the exhaust gas by said fuel addition means;
calculating the added fuel amount to be added during a rich continuation period, and controlling the fuel addition means such that fuel is added by dispersing the calculated added fuel amount over the rich continuation period, wherein said fuel amount is calculated by a control means based upon the intake air amount of the internal combustion engine, the fuel supply amount to the internal combustion engine, the target air fuel ratio during NOx reduction, and the rich continuation period over which this target air fuel ratio should be continued;
wherein, based upon the NOx purification ratio and the HC purification ratio in said NOx storage reduction catalyst, the number of times of fuel injection or the fuel injection ratio is varied.
